(19) United States
(12) Patent Application Publication
(10) Pub. No.: US 2012/0038758 A1
(43) Pub. Date: Feb. 16, 2012

(54) APPARATUS, METHOD AND ARTICLE FOR GENERATING A THREE DIMENSIONAL EFFECT USING ACTIVE GLASSES

(75) Inventors: Raif Khassanov, Sammamish, WA (US); Eugene Luskin, Issaquah, WA (US); Igor A. Gershman, Seattle, WA (US)

(73) Assignee: 3D DIGITAL, LLC, Seattle, WA (US)

(21) Appl. No.: 13/208,695

(22) Filed: Aug. 12, 2011

Related U.S. Application Data
(60) Provisional application No. 61/372,956, filed on Aug. 12, 2010.

(51) Int. Cl. H04N 13/04

(52) U.S. Cl. 348/60; 348/E13.075

(57) ABSTRACT

A system for producing a three dimensional (3D) effect from displayed images is provided. Images of a video program are displayed in a complementary primary colors-encoded stereoscopic image format, which includes stereoscopic images of objects or a scene. Corresponding stereoscopic images are displayed in different colors. As the display refreshes, the display alternates the colors of the corresponding stereoscopic images and sends a control signal to active glasses worn by a viewer of the video program that causes a left-eye lens and right-eye lens filter to alternate the color which is filtered in by the respective filter. The viewer is able to view the video program with a perceived 3D effect without either of the lenses of the active glasses having to become opaque during display of the complementary primary colors-encoded stereoscopic image.

### CROSS REFERENCE TO RELATED APPLICATIONS

This application claims benefit under 35 U.S.C. 119(e) to U.S. provisional patent application Ser. No. 61/372,956, entitled “ALTERNATING COLORS BETWEEN LEFT AND RIGHT EYE IN ORDER TO IMPROVE A STEREOSCOPIC 3D EFFECT CREATED BY COMPLIMENTARY PRIMARY COLORS ENCODED STEROSCOPIC IMAGES WHEN 2 COLOR GLASSES ARE USED” filed Aug. 12, 2010 (Atty. Docket No. 900200.402P1).

### BACKGROUND

1. Technical Field

The present disclosure generally relates to providing three dimensional (3D) visual effects from displayed images and may be useful in conjunction with and applicable to a variety of different video displays and video projectors.

2. Description of the Related Art

Producing increasingly better 3D visual effects has long since been an endeavor of many in the film industry, television industry and high-technology entertainment industry. Producing and displaying 3D moving pictures may be performed in a variety of ways. The basic requirement is to display offset (stereoscopic) images that are filtered separately to the left and right eye. Using the stereoscopic images is a technique for creating or enhancing the illusion of depth in an image by presenting two offset images separately to the left and right eye of the viewer. Both of these two dimensional (2D) offset images are then combined by one's brain to give the perception of 3D depth. Various techniques have been traditionally used to accomplish this.

One such technique is to have the viewer wear eyeglasses to filter the separate offset images to each eye. A traditional 3D display technology for projecting stereoscopic image pairs to users wearing special eyeglasses is referred to as anaglyphic 3D (with users wearing passive red-blue or red-cyan lenses). In anaglyphic 3D, displayed images are made up of two color layers, superimposed, but offset with respect to each other to produce a depth effect. Usually the main subject is in the center, while the foreground and background are shifted laterally in opposite directions. When viewed through the color-coded anaglyph eyeglasses, they reveal an integrated stereoscopic image. The visual cortex of the brain fuses this into perception of a three dimensional scene or composition. However, problems involving image ghosting, retinal rivalry, wrong colors and difficulty focusing are common.

Another traditional type of anaglyphic 3D technology that is commonly used in 3D television involves using liquid crystal shutter glasses (also referred to as LC shutter glasses or active shutter glasses). Liquid crystal shutter glasses are glasses used in conjunction with a display screen to create the illusion of a three dimensional image, an example of stereoscopy described above. The lens for each eye of the liquid crystal shutter glasses contains a liquid crystal layer which has the property of becoming dark when voltage is applied, being otherwise transparent. The glasses are controlled by wireless a transmitter from the display that sends a timing signal that allows the glasses to alternately darken over one eye, and then the other, in synchronization with the refresh rate of the screen of the display. Meanwhile, the display alternately displays different perspectives for each eye, using a technique referred to as alternate-frame sequencing, which achieves the desired effect of each eye seeing only the image intended for it. However, problems involving flickering at lower refresh rates of the display, pricing and double imaging at higher refresh rates of the display are common.

### BRIEF SUMMARY

A system for producing a three dimensional (3D) effect from displayed images is provided. Images of a video program are displayed in a complementary primary colors-encoded stereoscopic image format, which includes stereoscopic images of objects or a scene. Example complementary primary colors include red/cyan, green/magenta and blue/yellow. One example of such a format is an anaglyphic image. Corresponding stereoscopic images are displayed in different colors. In one embodiment, as the display refreshes, the display alternates the colors of the corresponding stereoscopic images and sends a control signal to active glasses worn by a viewer of the video program that causes a left-eye lens and right-eye lens filter to alternate the color which is filtered by the respective filter. The viewer is able to view the video program with a perceived 3D effect without either of the lenses of the active glasses having to become opaque during display of the complementary primary colors-encoded stereoscopic image.

A method of providing a three dimensional effect from an electronic display may be summarized as including displaying a first complementary primary colors-encoded stereoscopic image of a video program on the display corresponding to a first refresh of the display, the first complementary primary colors-encoded stereoscopic image including a first left-eye stereoscopic image of a first color and a corresponding first right-eye stereoscopic image of a second color; displaying a second complementary primary colors-encoded stereoscopic image of the video program on the display corresponding to a second refresh of the display, the second complementary primary colors-encoded stereoscopic image including a second left-eye stereoscopic image of the second color and a corresponding second right-eye stereoscopic image of the first color, the second complementary primary colors-encoded stereoscopic image related in a time sequence of the video program to the first complementary primary colors-encoded stereoscopic image; repeating the displaying a first complementary primary colors-encoded stereoscopic image and the displaying a second complementary primary colors-encoded stereoscopic image corresponding to subsequent refreshes of the display during display of at least a portion of the video program; and generating a control signal to be sent to active glasses, for each time the display refreshes during the display of the at least the portion of the video program, to cause the active glasses to alternate between a first state of filtering out the second color while allowing the first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a corresponding left-eye stereoscopic image is visible through the left-eye lens of the active glasses, and is not visible through the right-eye lens of the active glasses, and a corresponding right-eye stereoscopic image is concurrently visible through the right-eye lens of the active glasses, and is not visible through the left-eye lens of the active glasses.

The generating the control signal may include generating the control signal at a frequency equal to a refresh rate of the display. The refresh rate of the display may be approximately 60 Hz or approximately 50 Hz. The refresh rate of the display may be between approximately 60 Hz and approximately 240 Hz or between approximately 50 Hz and approximately 200 Hz. The generating the control signal may include generating the control signal in synchronization with each refresh of the display. The method may further include sending the control signal to the active glasses. The sending the control signal to the active glasses may include sending the control signal to the active glasses in synchronization with each refresh of the display. The sending the control signal to the active glasses may include sending the control signal to the active glasses at a frequency equal to a refresh rate of the display. The first color may be one of red, blue and green and the second color may be another one of red, blue and green different than the first color. The control signal may be a wireless signal. The display of the video program may be in reverse. Neither the left-eye lens nor right eye lens is opaque during the repeating the displaying a first complementary primary colors-encoded stereoscopic image and during the displaying a second complementary primary colors-encoded stereoscopic image for each time the display refreshes.

A method of providing a three dimensional effect from an electronic display may be summarized as including receiving a control signal for active glasses to cause the active glasses to alternate between a first state of filtering out a second color while allowing the first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a currently displayed corresponding left-eye stereoscopic image is visible through the left-eye lens of the active glasses while not being visible through the right-eye lens of the active glasses, and a concurrently displayed corresponding right-eye stereoscopic image is visible through the right-eye lens of the active glasses, while not being visible through the left-eye lens of the active glasses, as a video program is displayed on an electronic display, the video program displayed including at least one complementary primary colors-encoded stereoscopic image that alternates between displaying the corresponding left-eye stereoscopic image in the first color concurrently with the corresponding right-eye stereoscopic image in the second color and displaying the corresponding left-eye stereoscopic image in the second color concurrently with the corresponding right-eye stereoscopic image in the first color; and alternating between the first state and the second state according to the received control signal by changing filtering characteristics of the left-eye lens and right-eye lens.

The alternating between the first state and second state may include causing a liquid crystal filter of the left-eye lens to change filtering characteristics of the liquid crystal filter of the left-eye lens; and concurrently causing a liquid crystal filter of the right-eye lens to change filtering characteristics of the liquid crystal filter of the right-eye lens. The changing filtering characteristics may include changing polarization of electronically controlled polarized filters for the left-eye lens and the right-eye lens. The alternating between the first state and the second state may include alternating between the first state and the second state at a frequency equal to a refresh rate of the display. The alternating between the first state and the second state may include alternating between the first state and second state glasses in synchronization with each refresh of the display. The at least one complementary primary colors-encoded stereoscopic image that alternates may be caused by: displaying on the display a first complementary primary colors-encoded stereoscopic image of a video program on the display corresponding to a first refresh of the display, the first complementary primary colors-encoded stereoscopic image including a first left-eye stereoscopic image of a first color and a corresponding first right-eye stereoscopic image of a second color; displaying a second complementary primary colors-encoded stereoscopic image of the video program on the display corresponding to a second refresh of the display, the second complementary primary colors-encoded stereoscopic image including a second left-eye stereoscopic image of the second color and a corresponding second right-eye stereoscopic image of the first color, the second complementary primary colors-encoded stereoscopic image related in a time sequence of the video program to the first complementary primary colors-encoded stereoscopic image; and repeating the displaying a first complementary primary colors-encoded stereoscopic image and the displaying a second complementary primary colors-encoded stereoscopic image corresponding to subsequent refreshes of the display during display of at least a portion of the video program.

A pair of active glasses for viewing an electronic display may be summarized as including a left-eye lens; a right eye lens; and a control unit in operable communication with the left-eye lens and right-eye lens, the control unit configured to: receive a control signal for the active glasses to cause the active glasses to alternate between a first state of filtering out a second color while allowing the first color to pass through a left-eye lens of the active glasses and filtering out a first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a currently displayed corresponding left-eye stereoscopic image is visible through the left-eye lens of the active glasses, while not being visible through the right-eye lens of the active glasses, and a concurrently displayed corresponding right-eye stereoscopic image is visible through the right-eye lens of the active glasses, while not being visible through the left-eye lens of the active glasses, as a video program is displayed on an electronic display, the video program displayed including at least one complementary primary colors-encoded stereoscopic image that alternates between displaying the corresponding left-eye stereoscopic image in the first color concurrently with the corresponding right-eye stereoscopic image in the second color and displaying the corresponding left-eye stereoscopic image in the second color concurrently with the corresponding right-eye stereoscopic image in the first color; and cause the active glasses to alternate between the first state and second state according to the received control signal by changing filtering characteristics of the left-eye lens and right-eye lens.

The left-eye lens and right-eye lens may each include a liquid crystal filter operable to receive voltage caused by the received control signal to change filtering characteristics of the liquid crystal filter. The left-eye lens and right-eye lens may each include: an input polarizer configured to receive light from the display; a wavelength-dependent retarder coupled to the input polarizer configured to circularly polarize light of the first color in a first direction and circularly polarize light of the second color in a second direction; a wavelength-independent retarder coupled to the wavelength-dependent retarder configured to linearly polarize the circularly polarized light of the first color and linearly polarize the circularly polarized light of the second color; and a electronically controllable filter coupled to the wavelength-independent retarder operable to receive voltage to selectively filter the linearly polarized light of the of the first color and the linearly polarized light of the of the second color.

An electronic display may be summarized as including a display screen; a control unit operably coupled to the display screen, the control unit configured to: cause displaying of a first complementary primary colors-encoded stereoscopic image of a video program on the display corresponding to a first refresh of the display, the first complementary primary colors-encoded stereoscopic image including a first left-eye stereoscopic image of a first color and a corresponding first right-eye stereoscopic image of a second color; cause displaying of a second complementary primary colors-encoded stereoscopic image of the video program on the display corresponding to a second refresh of the display, the second complementary primary colors-encoded stereoscopic image including a second left-eye stereoscopic image of the second color and a corresponding second right-eye stereoscopic image of the first color, the second complementary primary colors-encoded stereoscopic image related in a time sequence to the first complementary primary colors-encoded stereoscopic image; repeat the displaying a first complementary primary colors-encoded stereoscopic image and the displaying a second complementary primary colors-encoded stereoscopic image corresponding to subsequent refreshes of the display during display of at least a portion of the video program; and generate a control signal to be sent to active glasses, for each time the display refreshes during the display of the at least the portion of the video program, to cause the active glasses to alternate between a first state of filtering out the second color while allowing the first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a corresponding left-eye stereoscopic image is visible through the left-eye lens of the active glasses, while not being visible through the right-eye lens of the active glasses, and a corresponding right-eye stereoscopic image concurrently visible through the right-eye lens of the active glasses, while not being visible through the left-eye lens of the active glasses.

The control signal may be a wireless signal. The display of the video program may be in reverse. The control unit may be configured to generate the control signal at a frequency equal to a refresh rate of the display. The refresh rate of the display may be approximately 60 Hz or approximately 50 Hz. The refresh rate of the display may be between approximately 60 Hz and approximately 240 Hz or between approximately 50 Hz and approximately 200 Hz. The control unit may be configured to generate the control signal in synchronization with each refresh of the display. The control unit may be further configured to send the control signal to the active glasses.

A nontransitory computer-readable medium that stores instructions executable by a processor to operate an electronic display, may be summarized as including displaying a first complementary primary colors-encoded stereoscopic image of a video program on the display corresponding to a first refresh of the display, the first complementary primary colors-encoded stereoscopic image including a first left-eye stereoscopic image of a first color and a corresponding first right-eye stereoscopic image of a second color; displaying a second complementary primary colors-encoded stereoscopic image of the video program on the display corresponding to a second refresh of the display, the second complementary primary colors-encoded stereoscopic image including a second left-eye stereoscopic image of the second color and a corresponding second right-eye stereoscopic image of the first color, the second complementary primary colors-encoded stereoscopic image related in a time sequence to the first complementary primary colors-encoded stereoscopic image; repeating the displaying a first complementary primary colors-encoded stereoscopic image and the displaying a second complementary primary colors-encoded stereoscopic image corresponding to subsequent refreshes of the display during display of at least a portion of the video program; and generating a control signal to be sent to active glasses, for each time the display refreshes during the display of the at least the portion of the video program, to cause the active glasses to alternate between a first state of filtering out the second color while allowing the first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a corresponding left-eye stereoscopic image is visible through the left-eye lens of the active glasses, while not being visible through the right-eye lens of the active glasses, and a corresponding right-eye stereoscopic image is concurrently visible through the right-eye lens of the active glasses, while not being visible through the left-eye lens of the active glasses.

The generating the control signal may include generating the control signal at a frequency equal to a refresh rate of the display. The refresh rate of the display may be approximately 60 Hz or approximately 50 Hz. The generating the control signal may include generating the control signal in synchronization with each refresh of the display.

A nontransitory computer-readable medium that stores instructions executable by a processor to operate a pair of active glasses, may be summarized as including receiving a control signal for the active glasses to cause the active glasses to alternate between a first state of filtering out a second color while allowing a first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a currently displayed corresponding left-eye stereoscopic image is visible through the left-eye lens of the active glasses, while not being visible through the right-eye lens of the active glasses, and a concurrently displayed corresponding right-eye stereoscopic image is visible through the right-eye lens of the active glasses, while not being visible through the left-eye lens of the active glasses, as a video program is displayed on an electronic display, the video program displayed including at least one complementary primary colors-encoded stereoscopic image that alternates between displaying the corresponding left-eye stereoscopic image in the first color concurrently with the corresponding right-eye stereoscopic image in the second color and displaying the corresponding left-eye stereoscopic image in the second color concurrently with the corresponding right-eye stereoscopic image in the first color; and causing the active glasses to alternate between the first state and the second state according to the received control signal by changing filtering characteristics of the left-eye lens and right-eye lens.

The causing the active glasses to alternate between the first state and the second state may include causing a liquid crystal filter of the left-eye lens to change filtering characteristics of the liquid crystal filter of the left-eye lens; and substantially simultaneously causing a liquid crystal filter of the right-eye lens to change filtering characteristics of the liquid crystal filter of the right-eye lens. The changing filtering characteristics may include changing polarization of electronically controlled polarized filters for the left-eye lens and right-eye lens. The causing the active glasses to alternate between the first state and the second state may include causing the active glasses to alternate between the first state and the second state at a frequency equal to a refresh rate of the display.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A and FIG. 1B are schematic views of a system for generating a three dimensional (3D) effect using active glasses, according to one non-limiting illustrated embodiment showing example images being displayed in sequence on a display of the system.

FIG. 2 is a timing diagram of screen refreshes of the display corresponding to what a left eye and a right eye of a user is seeing through the active glasses of the system for generating a 3D effect shown in FIG. 1A and FIG. 1B, according to one non-limiting illustrated embodiment.

FIG. 3 is a diagram of representations of active liquid crystal filters of the active glasses of the system for generating a 3D effect shown in FIG. 1A and FIG. 1B, according to one non-limiting illustrated embodiment.

FIG. 4 is a diagram of representations of a stack of polarizers, light wave retarders and filters of the active glasses of the system for generating a 3D effect shown in FIG. 1A and FIG. 1B, according to another non-limiting illustrated embodiment.

FIG. 5 is a schematic view of the active glasses 3D control unit and the display 3D control unit of the system for generating a 3D effect shown in FIG. 1A and FIG. 1B, according to one non-limiting illustrated embodiment.

FIG. 6 is a flow diagram showing a method of operating the display of the system for generating a 3D effect shown in FIG. 1A and FIG. 1B, according to one non-limiting illustrated embodiment.

FIG. 7 is a flow diagram showing a method of operating the active glasses of the system for generating a 3D effect shown in FIG. 1A and FIG. 1B, according to one non-limiting illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with 3D television systems, 3D television displays and active liquid crystal glasses have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment.

The use of ordinals such as first, second and third does not necessarily imply a ranked sense of order, but rather may only distinguish between multiple instances of an act or structure.

The headings and Abstract of the Disclosure provided herein are for convenience only and do not interpret the scope or meaning of the embodiments.

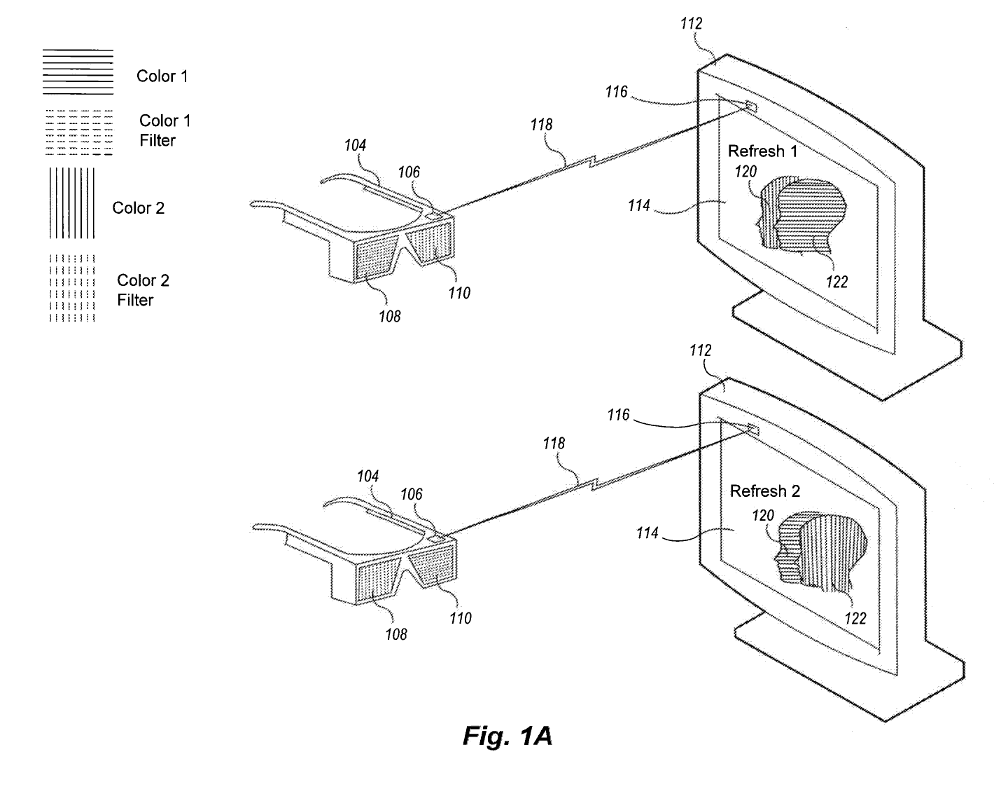

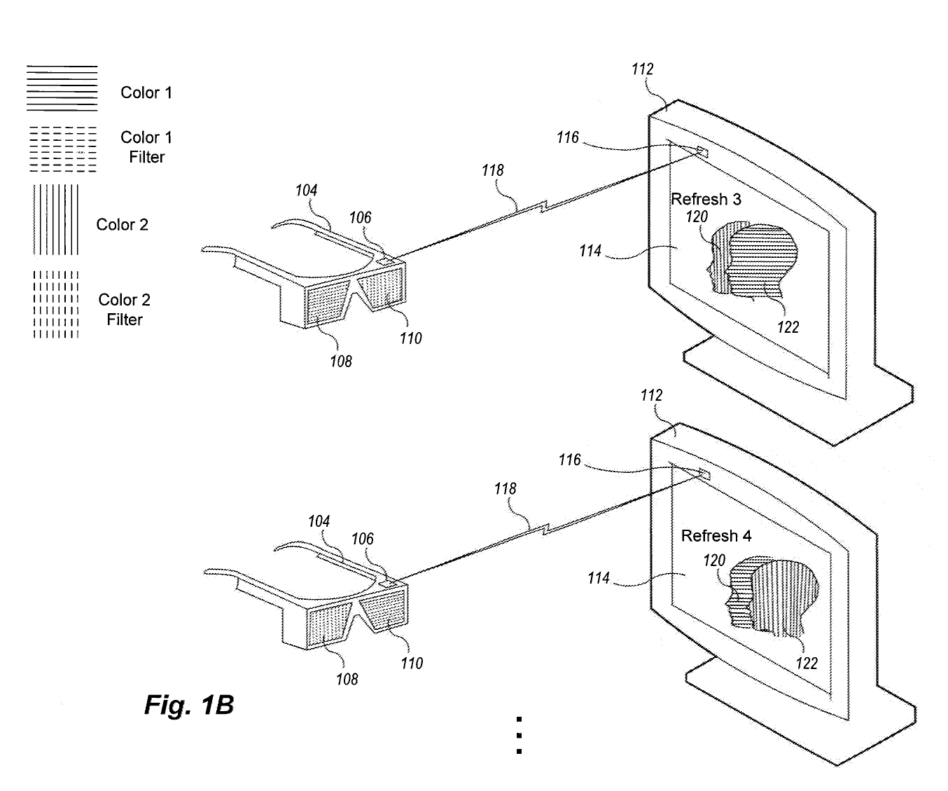

FIG. 1A and FIG. 1B are schematic views of a system for generating a 3D effect using active glasses 104 and showing example images being displayed for sequential refreshes (Refresh 1, Refresh 2, Refresh 3, Refresh 4) of the display. The refresh rate (also referred to as the “vertical refresh rate” or “vertical scan rate” for cathode ray tube devices) is the number of times in a second that display hardware draws the image data. This is distinct from the measure of frame rate in that the refresh rate may include the repeated drawing of identical frames, while frame rate measures how often a video source can feed an entire frame of new data to a display.

Shown are a pair of active glasses 104 in operable communication with a display 112. The display is configured to send a signal 118 (wireless or otherwise) to the active glasses 104 that controls individual filter characteristics of a left-eye lens 110 and right-eye lens 108 of the glasses 104. In particular, the control signal 118 is received from a transmitter of a display 3D control unit 116 by a signal receiver of a control unit 106 of the active glasses 104, which causes, according to the control signal, the left-eye lens 110 to have particular filter characteristics to filter out light of a particular color (e.g., color 1 shown for Refresh 1) and allow light through of a different color (e.g., color 2 shown for Refresh 1) emanating from the display of a left stereoscopic image 120 of a complementary primary colors-encoded stereoscopic image displayed on the screen 114. The preferred choice of the complementary colors that are used for encoding the stereoscopic image depends of the sensitivity of the human eye to different colors and preferably provides good luminary balance. For example, in the case of using 3 primary colors (red, green, blue) the preferred balance will give green/magenta complementary colors.

Concurrently, the control unit 106 of the active glasses 104 causes the right-eye lens 108 to have particular filter characteristics to filter out light of a different color (e.g., color 2 shown for Refresh 1) than does right-eye lens 110 and allow light through of a different color 108 (e.g., color 1 shown for Refresh 1) than does left-eye lens, which is emanating from the display of a corresponding right stereoscopic image 122 of the complementary primary colors-encoded stereoscopic image displayed on the screen 114. By filtering in the corresponding color 1 or color 2, the right-eye lens 108 and left-eye lens 110 also filter out the other color (color 1 or color 2) which is not currently being filtered in by the corresponding lens. To the user of the active glasses 104, this results in a perceived depth (or 3D effect) of the complementary primary colors-encoded stereoscopic image currently being displayed that includes the left stereoscopic image 120 and right stereoscopic image 122 fused by the user's mind in to one image with perceived depth.

The term color refers to the visual perceptual property corresponding in humans to the categories called red, green, blue and others. Color derives from the spectrum of light (distribution of light energy versus wavelength) interacting in the eye with the spectral sensitivities of the light receptors. The familiar colors of the rainbow in the spectrum include all those colors that can be produced by visible light of a single wavelength. Light of different single or multiple wavelengths within the electromagnetic spectrum have different colors.

For each adjacent subsequent refresh of the screen 114, the display 112 switches the color of the left stereoscopic image 120 and right stereoscopic image 122 and correspondingly generates the control signal 118 to be sent to alternate the color (e.g., color 1 or color 2) that the corresponding left-eye lens 110 and right-eye lens 108 is filtering in. This is shown on the display for Refresh 1 and Refresh 2 in FIG. 1A. Note that for Refresh 1, the left stereoscopic image 120 is displayed in color 2 and the right stereoscopic image 122 is displayed in color 1. Correspondingly, the left-eye lens 110 is illustrated to show (by use of illustrative vertical dashed lines on the left-eye lens 110) that it is filtering in color 2 of the left stereoscopic image 120 and the right-eye lens 108 is illustrated to show (by use of illustrative horizontal dashed lines on the right-eye lens 108) that it is filtering in color 1 of the right stereoscopic image 122. As shown in FIG. 1A, this configuration of the color in which the stereoscopic images are displayed and also the color which the left-eye lens 110 filters out and color it allows through, and the color which the right-eye lens 108 filters out and the color it allows through automatically alternates for the image displayed and viewed corresponding to Refresh 2. This alternation continues as shown in FIG. 1B for Refresh 3, which alternates back to the stereoscopic image color configuration of Frame 1. Then, for Refresh 4, the configuration alternates back to the stereoscopic image color configuration of Refresh 2. This alternation may continue for an entire video program or portions of the video program and may also be applied to the display of video frames in forward or reverse direction or in special play modes such as fast forward, rewind or slow-motion.

This alternation occurs substantially at the same frequency and substantially in synchronization with the refresh rate of the display 112. This causes the user of the glasses 104 to perceive a full color video image sequence with lessened color distortion and flickering compared to using a system with traditional active shutter glasses or other traditional 3D systems for displays. In one embodiment, the refresh rate of the display 112 may be approximately 50/60 Hz (e.g., in accordance with European/U.S. standards). However, the refresh rate may also be greater or less than 50/60 Hz, such as, for example, approximately 200/240 Hz (e.g., in accordance with European/U.S. standards). Preferably, the refresh rate is over approximately 50/60 Hz.

The alternation of the filtering of the two different colors between the left-eye lens 110 and right-eye lens 108 occurs in between the display of the images such that a user may see through both corresponding lenses 108, 110 during the concurrent display of the left stereoscopic image 120 and right stereoscopic image 122 during the display of each image. Preferably, this alternation occurs in less than approximately 2 ms. The alternation of the filtering as described herein may be applied to a variety of display systems and standards including, but not limited to, interlaced and non-interlaced systems, phase alternate line (PAL), National Television System Committee (NTSC) systems, progressive scan systems, plasma systems, liquid crystal display (LCD) systems, cathode ray tube (CRT) systems and various High Definition (HD) systems, etc.

The two different colors may be any two different colors that are different enough to be distinguished and filtered appropriately by the corresponding left-eye lens 110 and right-eye lens 108 to create the desired 3D effect. For example, color 1 may be any one of red, green and blue or a variation thereof and the color 2 is another one of red, green and blue or a variation thereof. In one embodiment, color 1 is red and color 2 is blue (or vice versa). In another embodiment, color 1 is red and color 2 is blue-green or cyan (or vice versa). The display 3D control unit 116 may be configured to send a wireless signal to the signal receiver of the control unit 106 of the active glasses 104 to control the filtering characteristics of the active glasses. In other embodiments, the signal may be other than wireless. This signal may be any suitable wireless or other signal for communication between the display 112 and the active glasses 104. For example, the signal may be, but is not limited to, an infrared signal, a radio frequency signal, a Digital Light Processing Link (DLP® Link) signal or a Bluetooth® signal, etc. Other embodiments include any other configuration or combination of configurations that allow synchronization between the glasses 104 and the display 112, including using an emitter from the glasses 104 to the display 112, a specific timing signal used by both the display 112 and glasses 104, etc.

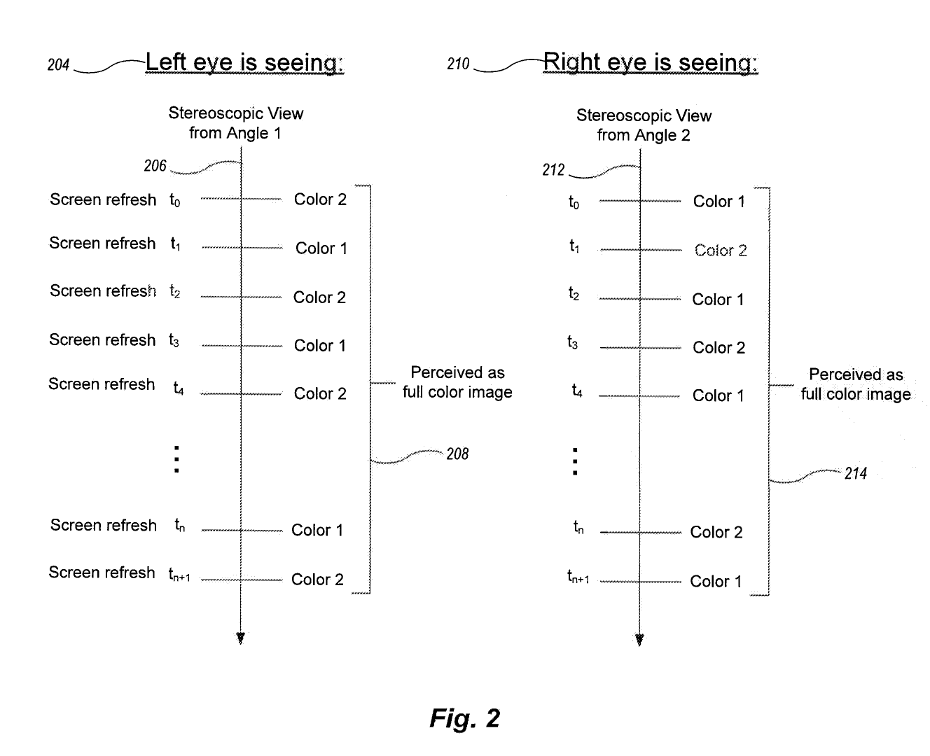

FIG. 2 is a timing diagram of example screen refreshes of the display 112 corresponding to what a left eye and a right eye of a user is seeing through the active glasses 104 of the system for generating a 3D effect shown in FIG. 1A and FIG. 1B. Shown is a timeline 206 corresponding to what the user's left eye is seeing 204 and a timeline 210 corresponding to what the user's right eye is concurrently seeing.

The left eye of the user is seeing a stereoscopic view of an object in a video frame from angle 1, while the right eye of the user is seeing a stereoscopic view of the same object in the same video from angle 2. As shown on timeline 206, at t₀ the left eye is seeing the stereoscopic view of the object in the video frame from angle 1 in color 2. As shown on timeline 212, at t₀ the right eye is simultaneously seeing the stereoscopic view of the object in the video frame from angle 2 in color 1. At t₁ the screen refreshes and this configuration automatically alternates. In particular, at t₁, the left eye is seeing the stereoscopic view of the object in the video frame from angle 1 in color 1 and the right eye is simultaneously seeing the stereoscopic view of the object in the video frame from angle 2 in color 2. This configuration continues to alternate at a frequency substantially equal to and substantially synchronized with the refresh rate of the display 112 until tₙ₋₁.

Although the color of the image being seen by the left eye is alternating each time the screen refreshes over a sequence of video images 208, the frequency of this alternation is so high that the user perceives the image in full or nearly full color. The same is true for the stereoscopic image sequence 214 being separately viewed by the right eye of the user. Thus, the 3D effect caused by the viewing of corresponding stereoscopic images individually by each eye of the user appears with lessened color distortion and flickering compared to traditional systems using active shutter glasses and other traditional 3D systems for displays.

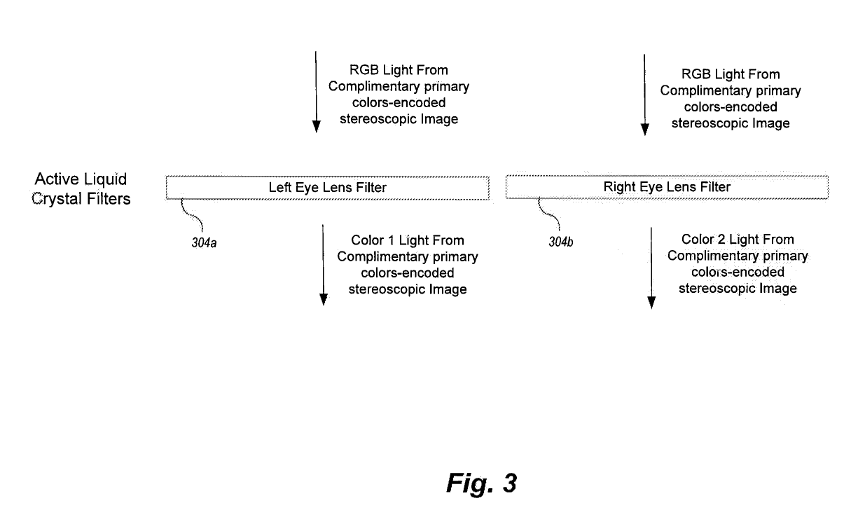

FIG. 3 is a diagram of representations of active liquid crystal filters 304a and 304b of the active glasses 104 of the system for generating a 3D effect shown in FIG. 1A and FIG. 1B. Shown is a representation of the left-eye lens filter 304a of the left-eye lens 110 of the active glasses 104 and also a representation of a right-eye lens filter 304b of the right-eye lens 108 of the active glasses 104. In the embodiment shown, the left-eye lens filter 304a and right-eye lens filter 304b are active liquid crystal filters operable to individually receive a voltage indicated and/or caused by the received control signal to independently change filtering characteristics of the liquid crystal filter to which the voltage is applied. A different voltage may be applied to the different filters at the same time as indicated and/or caused by the received control signal. In particular, filter 304a and filter 304b use electrically controlled liquid crystal elements to select a specific visible wavelength of light for transmission through the filter at the exclusion of other wavelengths of light. In some embodiments, the filters are controllable by altering the number of red, blue and green pixels, which allow for the reduction of lucidity changes when implemented in the 3D system described herein.

As seen in FIG. 3, red, green and blue light from the current complementary primary colors-encoded stereoscopic image being displayed is filtered by the left-eye lens filter 304a to filter out color 2 (and allow color 1 to pass through) emanating from the corresponding left stereoscopic image of the complementary primary colors-encoded stereoscopic image, while the right-eye lens filter 304b filters out color 1 (and allows color 2 to pass through) emanating from the corresponding right stereoscopic image of the complementary primary colors-encoded stereoscopic image. The left-eye lens filter 304a and right-eye lens filter 304b then alternate the color being filtered in synchronization with the refresh rate of the display 112 using the control signal from the display as described above.

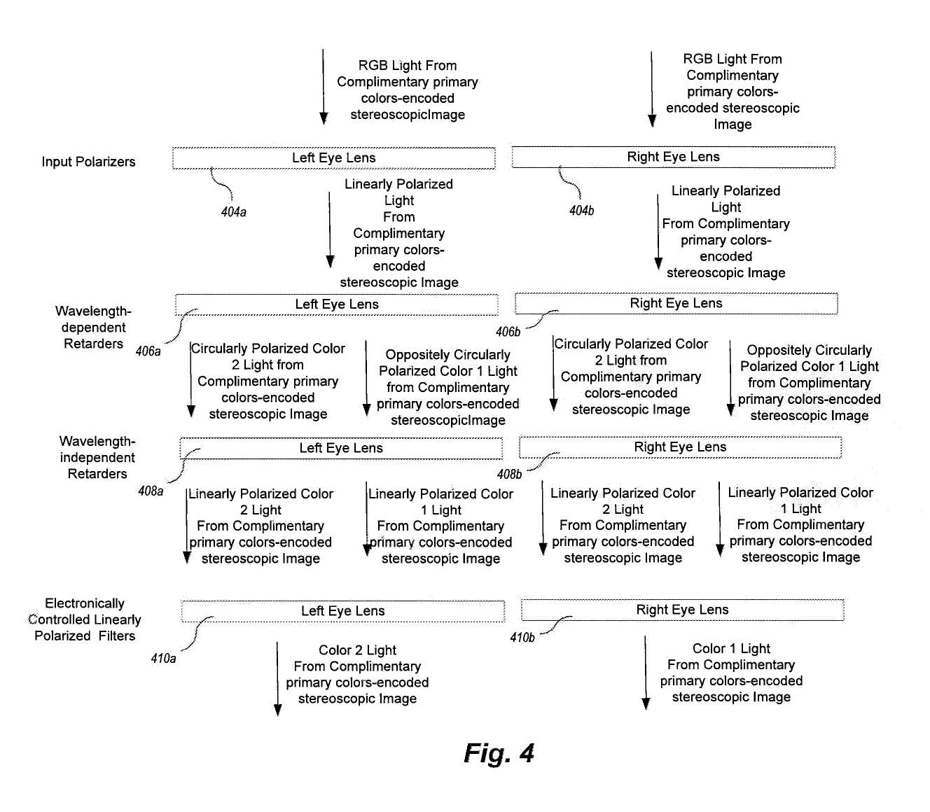

FIG. 4 is a diagram of a stack of polarizers 404a and 404b; light wave retarders 406a, 406b, 408a and 408b; and optical filters 410a and 410b, of the active glasses 104 of the system for generating a 3D effect shown in FIG. 1A and FIG. 1B.

The input polarizers 404a and 404b are configured to receive the full spectrum red, green, blue (RGB) light from the display 112 and linearly polarize the light from the display 112. If the light from the display 112 is already polarized, the polarizing direction of the input polarizers 404a and 404b should be aligned with the polarization of the light emanating from the display 112. The wavelength-dependent retarder 406a is coupled to the input polarizer 404a and is configured to circularly polarize light of the first color (i.e., the color of the left stereoscopic image of the displayed complementary primary colors-encoded stereoscopic image) in a first direction and to circularly polarize light of the second color (i.e., the color of the right stereoscopic image of the displayed complementary primary colors-encoded stereoscopic image) in a second direction opposite to the first direction. The wavelength-dependent retarder 406b is similarly configured.

In one example embodiment, the wavelength-dependent retarders 406a and 406b are configured to shift the incoming light wave 100% along the x axis (½ wavelength) and 50% along the y axis (¼ wavelength) for 650 nm wavelength light. Also, in the example embodiment, the wavelength-dependent retarders 406a and 406b are configured to shift the incoming light wave 50% along the x axis (¼ wavelength) and 100% along the y axis (½ wavelength) for 546 nm wavelength light and 436 nm wavelength light. The axes of the wavelength-dependent retarders 406a and 406b are turned 45 degrees relative to the axis of the input polarizer 404a and 404b, respectively. In this way, the red spectrum light (of a 650 nm wavelength) becomes circularly polarized in one direction and the blue-green light (of a 546 nm wavelength and a 436 nm wavelength) becomes circularly polarized in the opposite direction.

The wavelength-independent retarder 408a is coupled to the wavelength-dependent retarder 406a and is configured to linearly polarize the circularly polarized light of the first color and also to linearly polarize the circularly polarized light of the second color. The wavelength-independent retarder 408b is coupled to the wavelength-dependent retarder 406b and is also configured to linearly polarize the circularly polarized light of the first color and to linearly polarize the circularly polarized light of the second color.

The electronically controllable optical filter 410a is coupled to the wavelength-independent retarder 408a and is operable to receive voltage caused and/or indicated by the control signal from the display 112 to selectively filter out the linearly polarized light of the first color and selectively allow light through of the second color. The electronically controllable optical filter 410b is coupled to the wavelength-independent retarder 408b, but instead is operable to receive voltage caused and/or indicated by the control signal from the display 112 to selectively filter out the linearly polarized light of the second color and selectively allow light through of the first color. Any electronically controllable optical filter may be utilized. Other applicable filters or layers may be included in the stack described above. A filter configuration including the components as described above, when used in conjunction with the processes described herein, would cause the active glasses 104 to provide the user a 3D effect that results in lessened lucidity loss due to the use of wave retarders to circularly polarize the light of individual corresponding stereoscopic images in different directions and would also result in easier control than traditional 3D systems for electronic displays.

Also, U.S. Pat. No. 5,751,384, entitled “Color polarizers for polarizing an additive color spectrum along a first axis and it's compliment along a second axis,” which is incorporated by reference herein in its entirety, describes a method of producing orthogonally polarized complementary primary colors which may be used in conjunction with the methods and systems described herein.

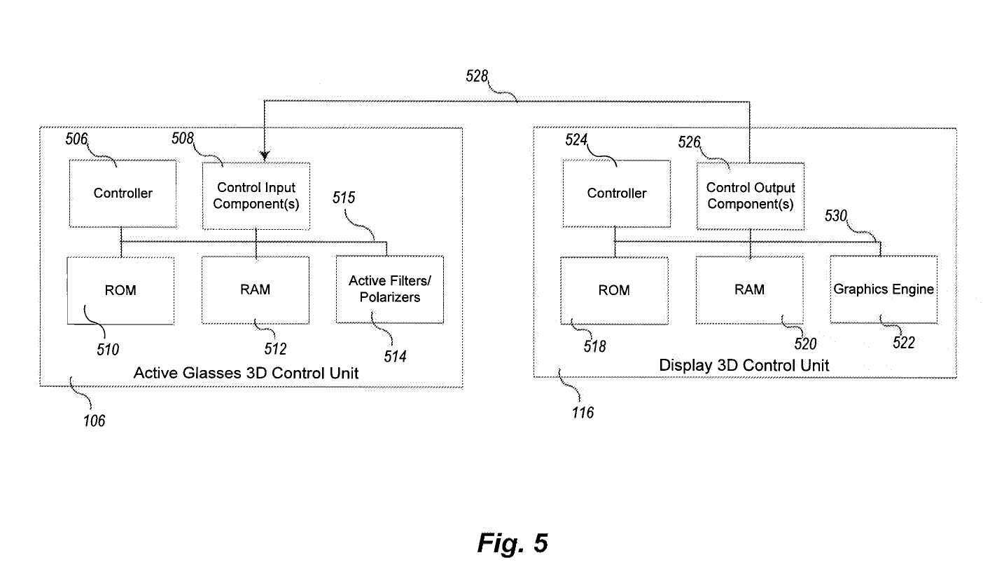

FIG. 5 is a schematic view of the active glasses 3D control unit 106 and the display 3D control unit 116 of the system for generating a 3D effect shown in FIG. 1A and FIG. 1B. The active glasses 3D control unit 106 includes a controller 506, one or more control input components 508, read only memory (ROM) 510, random access memory (RAM) 512, and the active filters/polarizers 514, each operably coupled to each other via a system bus 515. The display 3D control unit 116 includes a controller 524, one or more control output components 526, ROM 18, RAM 520, and a display graphics engine 522, each operably coupled to each other via a system bus 530.

For example the controller 506 may be a microprocessor, microcontroller, programmable logic controller (PLC), programmable gate array (PGA), application specific integrated circuit (ASIC) or another controller capable of receiving signals from various inputs (including from the control input components 508), performing logical operations, and sending signals to various components. Typically, the controller 506 may take the form of a microprocessor (e.g., INTEL, AMD, ATOM). As shown, the Active Glasses 3D control unit 106 may also include one or more non-transitory processor- or computer-readable storage media, for example read only ROM 510 and RAM 512. The non-transitory processor- or computer-readable storage media 510 and 512 may be in addition to any non-transitory storage medium (e.g., registers) which is part of the controller 506. As shown, the active glasses 3D control unit 106 may include one or more buses 515 (only one illustrated) coupling various components together, for example one or more power buses, instruction buses, data buses, etc.

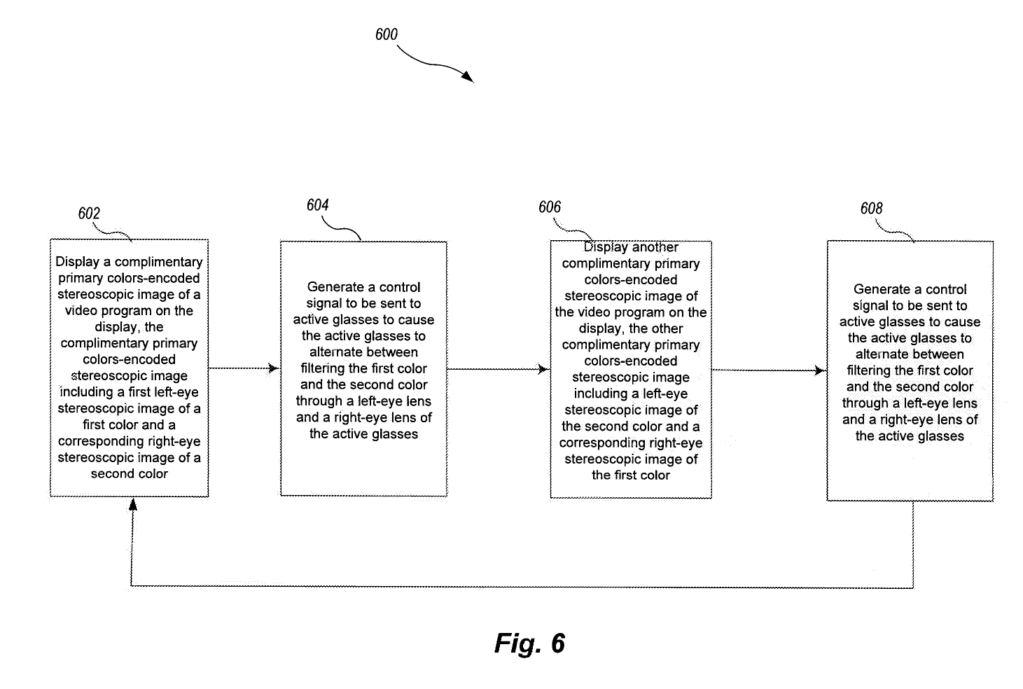

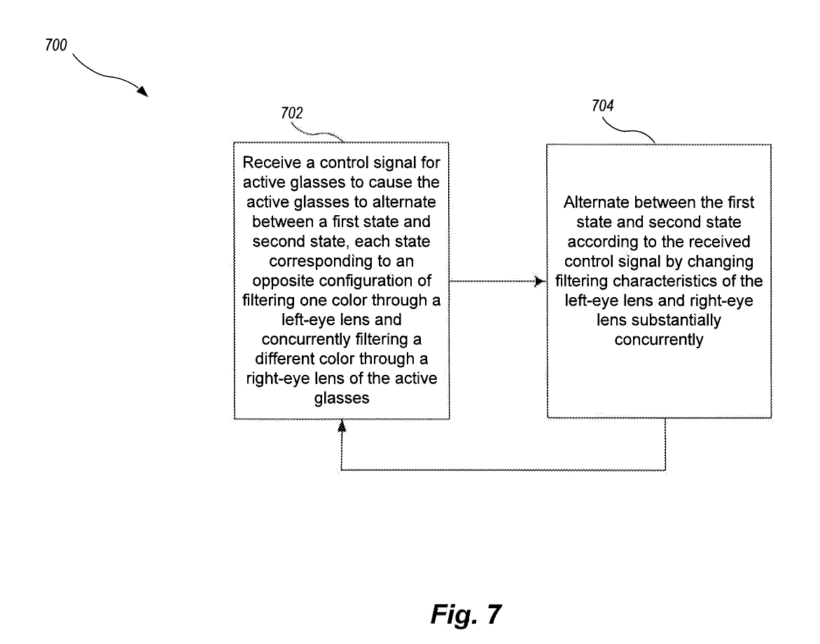

As illustrated the ROM 510 or RAM 512, stores instructions and/or data or values for variables or parameters. The sets of data may take a variety of forms, for example a lookup table, a set of records in a database, etc. The instructions and sets of data or values are executable by the controller 506. Execution of which causes the controller 506 to perform specific acts to cause the alternation of filtering characteristics of the filters 514 in the individual left-eye and right-eye lenses of the active glasses 104. Specific operation of the alternation of filtering characteristics of the individual left-eye and right-eye lenses of the active glasses 104 is described above and further below with reference to various flow diagrams (FIG. 6 and FIG. 7).

The controller 506 may use RAM 512 in a conventional fashion, for volatile storage of instructions, data, etc. The controller 506 may store data corresponding to the particular configurations of the filter or filters 514 used by the active glasses 104 and also configuration data related to the display 112 or the display 3D control unit 116. The instructions are executable by the controller 506 to control operation of the filters 514 of the individual left-eye and right-eye lenses of the active glasses 104.

The control input components 508 are configured to receive control signals 528 from the display 3D control unit 116 that are input to the controller 506 which causes the alternation of filtering characteristics of the filters 514 in the individual left-eye and right-eye lenses of the active glasses 104 according to the received control signals 528 indicative of such alternation. For example, the control input components 508 may be those configured to receive signals including, but not limited to one or more of: infrared signals, radio frequency signals, (Digital Light Processing) Link (DLP® Link) signals or a Bluetooth® signals.

Also, the controller 524 of the display 3D control unit 116 may be a microprocessor, microcontroller, programmable logic controller (PLC), programmable gate array (PGA), application specific integrated circuit (ASIC) or another controller capable of sending signals to various outputs (including the control output components 526), performing logical operations, and sending signals to various other components. Typically, the controller 524 may take the form of a microprocessor (e.g., INTEL, AMD, ATOM). As shown, the display 3D control unit 116 may also include one or more non-transitory processor- or computer-readable storage media, for example read only ROM 518 and RAM 520. The non-transitory processor- or computer-readable storage media 510 and 512 may be in addition to any non-transitory storage medium (e.g., registers) which is part of the controller 524. As shown, the display 3D control unit 116 may also include one or more buses 530 (only one illustrated) coupling various components together, for example one or more power buses, instruction buses, data buses, etc.

As illustrated the ROM 518 and RAM 520, stores instructions and/or data or values for variables or parameters. The sets of data may take a variety of forms, for example a lookup table, a set of records in a database, etc. The instructions and sets of data or values are executable by the controller 506. Execution of which causes the controller 524 to perform specific acts to cause the generating and sending of a control signal to cause the alternation of filtering characteristics of the filters 514 in the individual left-eye and right-eye lenses of the active glasses 104 synchronized with the refresh rate of the display 112. Execution of instructions by the controller 524 also causes the controller 524 to perform specific acts to cause the display 112 to display complementary primary colors-encoded stereoscopic images with corresponding stereoscopic images of different colors and to switch the colors between the left stereoscopic image and right stereoscopic images each time the display 112 refreshes. Specific operation of the signal generation and complementary primary colors-encoded stereoscopic image displaying is described above and further below with reference to various flow diagrams (FIG. 6 and FIG. 7).

The controller 524 may use RAM 520 in a conventional fashion, for volatile storage of instructions, data, etc. The controller 524 may store data corresponding to the particular configurations of the filter or filters 514 used by the active glasses 104 and also configuration data related to the display 112, the codec of the graphics engine 522, the refresh rate of the display 112, the format of the video being displayed, or the active glasses 3D control unit 106, etc. The instructions are executable by the controller 524 to control the signal generation for operation of the filters 514 of the individual left-eye and right-eye lenses of the active glasses 104 and to control the color of the complementary primary colors-encoded stereoscopic images displayed on the display 112 at any given time.

The control output components 526 are configured to send control signals 528 to the active glasses 3D control unit 106 which causes the alternation of filtering characteristics of the filters 514 in the individual left-eye and right-eye lenses of the active glasses 104 according to the received control signals 528 indicative of such alternation. For example the output components 526 may be those configured to send signals including, but not limited to, one or more of: infrared signals, a radio frequency signals, (Digital Light Processing) Link (DLP® Link) signals and Bluetooth® signals.

FIG. 6 is a flow diagram showing a method 600 of operating the display 112 of the system for generating a 3D effect shown in FIG. 1A and FIG. 1B.

At 602, the display 112 may display a complementary primary colors-encoded stereoscopic image of a video program on the display 112. The complementary primary colors-encoded stereoscopic image includes a first left-eye stereoscopic image of a first color and a corresponding right-eye stereoscopic image of a second color.

At 604, the display 112 may then generate a control signal to be sent to the active glasses 104 to cause the active glasses 104 to alternate between filtering the first color and the second color through a left-eye lens and a right-eye lens of the active glasses.

At 606, the display 112 may then display another complementary primary colors-encoded stereoscopic image of the video program on the display 112, the other complementary primary colors-encoded stereoscopic image including a left-eye stereoscopic image of the second color and a corresponding right-eye stereoscopic image of the first color.

At 608, the display 112 may then generate a control signal to be sent to active glasses 104 to cause the active glasses 104 to alternate between filtering the first color and the second color through a left-eye lens and a right-eye lens of the active glasses 104.

The process may then repeat starting again at 602. For example, the process may repeat each time the display 112 refreshes in a manner to synchronize the alternation of the filtering the first color and the second color by the display glasses with the refresh rate and with the corresponding display of the left-eye stereoscopic image and the right-eye stereoscopic image in corresponding different colors.

FIG. 7 is a flow diagram showing a method 700 of operating the active glasses 104 of the system for generating a 3D effect shown in FIG. 1A and FIG. 1B.

At 702, the active glasses 104 receive a control signal for the active glasses 104 to cause them to alternate between a first state and second state, each state corresponding to an opposite configuration of filtering one color through a left-eye lens and concurrently filtering different color through a right-eye lens of the active glasses.

At 704, the active glasses 104 alternate between the first state and second state according to the received control signal by changing filtering characteristics of the left-eye lens and right-eye lens substantially concurrently.

The process may then repeat starting at 702. The process may repeat at a rate equal to and in synchronization with the refresh rate of a display displaying a sequence of left-eye stereoscopic images and corresponding right-eye stereoscopic images in different colors corresponding to those being filtered in by the corresponding left-eye lens or right eye-lens.

The various methods described herein may include additional acts, omit some acts, and/or may perform the acts in a different order than set out in the various flow diagrams.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via one or more microcontrollers. However, those skilled in the art will recognize that the embodiments disclosed herein, in whole or in part, can be equivalently implemented in standard integrated circuits (e.g., Application Specific Integrated Circuits or ASICs), as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and/or firmware would be well within the skill of one of ordinary skill in the art in light of the teachings of this disclosure.

When logic is implemented as software and stored in memory, logic or information can be stored on any non-transitory computer-readable medium for use by or in connection with any processor-related system or method. In the context of this disclosure, a memory is a nontransitory computer- or processor-readable storage medium that is an electronic, magnetic, optical, or other physical device or means that non-transitorily contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any physical element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), and digital tape.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to: U.S. provisional patent application Ser. No. 61/372,956 entitled “ALTERNATING COLORS BETWEEN LEFT AND RIGHT EYE IN ORDER TO IMPROVE A STEREOSCOPIC 3D EFFECT CREATED BY COMPLEMENTARY PRIMARY COLORS-ENCODED STEREOSCOPIC IMAGES WHEN 2 COLOR GLASSES ARE USED” and filed Aug. 12, 2010 (Atty. Docket No. 900200.402P1) are incorporated herein by reference, in their entirety. Aspects of the embodiments can be modified, if necessary, to employ systems, circuits and concepts of the various patents, applications and publications to provide yet further embodiments. Note that “2 Color Glasses” refers to glasses that filter a different color for each lens, not 2 pairs of glasses.

While generally discussed in the environment and context of providing 3D effects for electronic displays, the teachings herein can be applied in a wide variety of other environments, including, but not limited to, other 3D systems for film, video projectors, screen, theater display systems, medical imaging technology, vision therapy and vision testing and mechanically driven active glasses, etc.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

I claim:

1. A method of providing a three dimensional effect from an electronic display comprising:
displaying a first complementary primary colors-encoded stereoscopic image of a video program on the display corresponding to a first refresh of the display, the first complementary primary colors-encoded stereoscopic image including a first left-eye stereoscopic image of a first color and a corresponding first right-eye stereoscopic image of a second color;
displaying a second complementary primary colors-encoded stereoscopic image of the video program on the display corresponding to a second refresh of the display, the second complementary primary colors-encoded stereoscopic image including a second left-eye stereoscopic image of the second color and a corresponding second right-eye stereoscopic image of the first color, the second complementary primary colors-encoded stereoscopic image related in a time sequence of the video program to the first complementary primary colors-encoded stereoscopic image;
repeating the displaying a first complementary primary colors-encoded stereoscopic image and the displaying a second complementary primary colors-encoded stereoscopic image corresponding to subsequent refreshes of the display during display of at least a portion of the video program; and
generating a control signal to be sent to active glasses, for each time the display refreshes during the display of the at least the portion of the video program, to cause the active glasses to alternate between a first state of filtering out the second color while allowing the first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a corresponding left-eye stereoscopic image is visible through the left-eye lens of the active glasses, and is not visible through the right-eye lens of the active glasses, and a corresponding right-eye stereoscopic image is concurrently visible through the right-eye lens of the active glasses, and is not visible through the left-eye lens of the active glasses.

2. The method of claim 1 wherein the generating the control signal includes generating the control signal at a frequency equal to a refresh rate of the display.

3. The method of claim 2 wherein the first complementary primary colors-encoded stereoscopic image and the second complementary primary colors-encoded stereoscopic image are anaglyphic images.

4. The method of claim 2 wherein the refresh rate of the display is between approximately 60 Hz and approximately 240 Hz or between approximately 50 Hz and approximately 200 Hz.

5. The method of claim 1 wherein the generating the control signal includes generating the control signal in synchronization with each refresh of the display.

6. The method of claim 1 further comprising sending the control signal to the active glasses.

7. The method of claim 6 wherein the sending the control signal to the active glasses includes sending the control signal to the active glasses in synchronization with each refresh of the display.

8. The method of claim 6 wherein the sending the control signal to the active glasses includes sending the control signal to the active glasses at a frequency equal to a refresh rate of the display.

9. The method of claim 1 wherein the first color is one of red, blue and green and the second color is another one of red, blue and green different than the first color.

10. The method of claim 1 wherein the control signal is a wireless signal.

11. The method of claim 1 wherein the display of the video program is in reverse.

12. The method of claim 1 wherein neither the left-eye lens nor right eye lens is opaque during the repeating the displaying a first complementary primary colors-encoded stereoscopic image and during the displaying a second complementary primary colors-encoded stereoscopic image for each time the display refreshes.

13. A method of providing a three dimensional effect from an electronic display comprising:
receiving a control signal for active glasses to cause the active glasses to alternate between a first state of filtering out a second color while allowing the first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a currently displayed corresponding left-eye stereoscopic image is visible through the left-eye lens of the active glasses while not being visible through the right-eye lens of the active glasses, and a concurrently displayed corresponding right-eye stereoscopic image is visible through the right-eye lens of the active glasses, while not being visible through the left-eye lens of the active glasses, as a video program is displayed on an electronic display, the video program displayed including at least one complementary primary colors-encoded stereoscopic image that alternates between displaying the corresponding left-eye stereoscopic image in the first color concurrently with the corresponding right-eye stereoscopic image in the second color and displaying the corresponding left-eye stereoscopic image in the second color concurrently with the corresponding right-eye stereoscopic image in the first color; and
alternating between the first state and the second state according to the received control signal by changing filtering characteristics of the left-eye lens and right-eye lens.

14. The method of claim 13 wherein the alternating between the first state and second state includes:
causing a liquid crystal filter of the left-eye lens to change filtering characteristics of the liquid crystal filter of the left-eye lens; and
concurrently causing a liquid crystal filter of the right-eye lens to change filtering characteristics of the liquid crystal filter of the right-eye lens.

15. The method of claim 13 wherein the changing filtering characteristics includes changing polarization of electronically controlled polarized filters for the left-eye lens and the right-eye lens.

16. The method of claim 13 wherein the alternating between the first state and the second state includes alternating between the first state and the second state at a frequency equal to a refresh rate of the display.

17. The method of claim 16 wherein the alternating between the first state and the second state includes alternating between the first state and second state glasses in synchronization with each refresh of the display.

18. The method of claim 13 wherein the at least one complementary primary colors-encoded stereoscopic image that alternates is caused by:
displaying on the display a first complementary primary colors-encoded stereoscopic image of a video program on the display corresponding to a first refresh of the display, the first complementary primary colors-encoded stereoscopic image including a first left-eye stereoscopic image of a first color and a corresponding first right-eye stereoscopic image of a second color;
displaying a second complementary primary colors-encoded stereoscopic image of the video program on the display corresponding to a second refresh of the display, the second complementary primary colors-encoded stereoscopic image including a second left-eye stereoscopic image of the second color and a corresponding second right-eye stereoscopic image of the first color, the second complementary primary colors-encoded stereoscopic image related in a time sequence of the video program to the first complementary primary colors-encoded stereoscopic image; and
repeating the displaying a first complementary primary colors-encoded stereoscopic image and the displaying a second complementary primary colors-encoded stereoscopic image corresponding to subsequent refreshes of the display during display of at least a portion of the video program.

19. A pair of active glasses for viewing an electronic display comprising:
a left-eye lens;
a right eye lens; and
a control unit in operable communication with the left-eye lens and right-eye lens, the control unit configured to:
receive a control signal for the active glasses to cause the active glasses to alternate between a first state of filtering out a second color while allowing the first color to pass through a left-eye lens of the active glasses and filtering out a first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a currently displayed corresponding left-eye stereoscopic image is visible through the left-eye lens of the active glasses, while not being visible through the right-eye lens of the active glasses, and a concurrently displayed corresponding right-eye stereoscopic image is visible through the right-eye lens of the active glasses, while not being visible through the left-eye lens of the active glasses, as a video program is displayed on an electronic display, the video program displayed including at least one complementary primary colors-encoded stereoscopic image that alternates between displaying the corresponding left-eye stereoscopic image in the first color concurrently with the corresponding right-eye stereoscopic image in the second color and displaying the corresponding left-eye stereoscopic image in the second color concurrently with the corresponding right-eye stereoscopic image in the first color; and
cause the active glasses to alternate between the first state and second state according to the received control signal by changing filtering characteristics of the left-eye lens and right-eye lens.

20. The pair of active glasses of claim 19 wherein the left-eye lens and right-eye lens each include a liquid crystal filter operable to receive voltage caused by the received control signal to change filtering characteristics of the liquid crystal filter.

21. The pair of active glasses of claim 19 wherein the left-eye lens and right-eye lens each include:
an input polarizer configured to receive light from the display;
a wavelength-dependent retarder coupled to the input polarizer configured to circularly polarize light of the first color in a first direction and circularly polarize light of the second color in a second direction;
a wavelength-independent retarder coupled to the wavelength-dependent retarder configured to linearly polarize the circularly polarized light of the first color and linearly polarize the circularly polarized light of the second color; and
a electronically controllable filter coupled to the wavelength-independent retarder operable to receive voltage to selectively filter the linearly polarized light of the of the first color and the linearly polarized light of the of the second color.

22. An electronic display comprising:
a display screen;
a control unit operably coupled to the display screen, the control unit configured to:
cause displaying of a first complementary primary colors-encoded stereoscopic image of a video program on the display corresponding to a first refresh of the display, the first complementary primary colors-encoded stereoscopic image including a first left-eye stereoscopic image of a first color and a corresponding first right-eye stereoscopic image of a second color;
cause displaying of a second complementary primary colors-encoded stereoscopic image of the video program on the display corresponding to a second refresh of the display, the second complementary primary colors-encoded stereoscopic image including a second left-eye stereoscopic image of the second color and a corresponding second right-eye stereoscopic image of the first color, the second complementary primary colors-encoded stereoscopic image related in a time sequence to the first complementary primary colors-encoded stereoscopic image;
repeat the displaying a first complementary primary colors-encoded stereoscopic image and the displaying a second complementary primary colors-encoded stereoscopic image corresponding to subsequent refreshes of the display during display of at least a portion of the video program; and
generate a control signal to be sent to active glasses, for each time the display refreshes during the display of the at least the portion of the video program, to cause the active glasses to alternate between a first state of filtering out the second color while allowing the first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a corresponding left-eye stereoscopic image is visible through the left-eye lens of the active glasses, while not being visible through the right-eye lens of the active glasses, and a corresponding right-eye stereoscopic image concurrently visible through the right-eye lens of the active glasses, while not being visible through the left-eye lens of the active glasses.

23. The electronic display of claim 22 wherein the control signal is a wireless signal.

24. The electronic display of claim 22 wherein the display of the video program is in reverse.

25. The electronic display of claim 22 wherein the control unit is configured to generate the control signal at a frequency equal to a refresh rate of the display.

26. The electronic display of claim 25 wherein the refresh rate of the display is approximately 50 Hz or approximately 60 Hz.

27. The electronic display of claim 25 wherein the refresh rate of the display is between approximately 60 Hz and approximately 240 Hz or between approximately 50 Hz and approximately 200 Hz.

28. The electronic display of claim 22 wherein the control unit is configured to generate the control signal in synchronization with each refresh of the display.

29. The electronic display of claim 22 wherein the control unit is further configured to send the control signal to the active glasses.

30. A nontransitory computer-readable medium that stores instructions executable by a processor to operate an electronic display, by:
displaying a first complementary primary colors-encoded stereoscopic image of a video program on the display corresponding to a first refresh of the display, the first complementary primary colors-encoded stereoscopic image including a first left-eye stereoscopic image of a first color and a corresponding first right-eye stereoscopic image of a second color;
displaying a second complementary primary colors-encoded stereoscopic image of the video program on the display corresponding to a second refresh of the display, the second complementary primary colors-encoded stereoscopic image including a second left-eye stereoscopic image of the second color and a corresponding second right-eye stereoscopic image of the first color, the second complementary primary colors-encoded stereoscopic image related in a time sequence to the first complementary primary colors-encoded stereoscopic image;
repeating the displaying a first complementary primary colors-encoded stereoscopic image and the displaying a second complementary primary colors-encoded stereoscopic image corresponding to subsequent refreshes of the display during display of at least a portion of the video program; and
generating a control signal to be sent to active glasses, for each time the display refreshes during the display of the at least the portion of the video program, to cause the active glasses to alternate between a first state of filtering out the second color while allowing the first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a corresponding left-eye stereoscopic image is visible through the left-eye lens of the active glasses, while not being visible through the right-eye lens of the active glasses, and a corresponding right-eye stereoscopic image is concurrently visible through the right-eye lens of the active glasses, while not being visible through the left-eye lens of the active glasses.

31. The nontransitory computer-readable medium of claim 30 wherein the generating the control signal includes generating the control signal at a frequency equal to a refresh rate of the display.

32. The nontransitory computer-readable medium of claim 31 wherein the refresh rate of the display is approximately 60 Hz or approximately 50 Hz.

33. The nontransitory computer-readable medium of claim 30 wherein the generating the control signal includes generating the control signal in synchronization with each refresh of the display.

34. A nontransitory computer-readable medium that stores instructions executable by a processor to operate a pair of active glasses, by:
receiving a control signal for the active glasses to cause the active glasses to alternate between a first state of filtering out a second color while allowing a first color to pass through a left-eye lens of the active glasses and filtering out the first color while allowing the second color to pass through a right-eye lens of the active glasses and a second state of filtering out the first color while allowing the second color to pass through the left-eye lens of the active glasses and filtering out the second color while allowing the first color to pass through the right-eye lens of the active glasses such that a currently displayed corresponding left-eye stereoscopic image is visible through the left-eye lens of the active glasses, while not being visible through the right-eye lens of the active glasses, and a concurrently displayed corresponding right-eye stereoscopic image is visible through the right-eye lens of the active glasses, while not being visible through the left-eye lens of the active glasses, as a video program is displayed on an electronic display, the video program displayed including at least one complementary primary colors-encoded stereoscopic image that alternates between displaying the corresponding left-eye stereoscopic image in the first color concurrently with the corresponding right-eye stereoscopic image in the second color and displaying the corresponding left-eye stereoscopic image in the second color concurrently with the corresponding right-eye stereoscopic image in the first color; and
causing the active glasses to alternate between the first state and the second state according to the received control signal by changing filtering characteristics of the left-eye lens and right-eye lens.

35. The nontransitory computer-readable medium of claim 34 wherein the causing the active glasses to alternate between the first state and the second state includes:
causing a liquid crystal filter of the left-eye lens to change filtering characteristics of the liquid crystal filter of the left-eye lens; and
substantially simultaneously causing a liquid crystal filter of the right-eye lens to change filtering characteristics of the liquid crystal filter of the right-eye lens.

36. The nontransitory computer-readable medium of claim 34 wherein the changing filtering characteristics includes changing polarization of electronically controlled polarized filters for the left-eye lens and right-eye lens.

37. The nontransitory computer-readable medium of claim 34 wherein the causing the active glasses to alternate between the first state and the second state includes causing the active glasses to alternate between the first state and the second state at a frequency equal to a refresh rate of the display.
